(19) United States
(12) Patent Application Publication
(10) Pub. No.: US 2004/0219385 A1
(43) Pub. Date: Nov. 4, 2004

(54) Process for curing powder coatings

(76) Inventors: Rene Mattern, Essenbach (DE); Joerg Reiter, Nuernberg (DE); Frank Zimmermann, Frontenhausen (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/643,606

(22) Filed: Aug. 18, 2003

Related U.S. Application Data
(60) Provisional application No. 60/405,521, filed on Aug. 23, 2002.

(51) Int. Cl. B05D 3/00; B32B 9/04

(52) U.S. Cl. 428/689; 427/551; 427/180; 428/446

(57) ABSTRACT

The invention provides a process for curing powder coatings which makes it possible to fuse and cure powder coatings using NIR radiation and which gives rise to coatings having improved mechanical properties, improved flow and increased uniformity of surface gloss of the coating;

the process for curing powder coatings is charactirized by fusing and curing the powder coatings with NIR radiation, which radiation spectrum is restricted by controlled filtration of the NIR radiation to a wavelength range of 250 to 3000 nanometres, preferably of 750 to 1800 nanometres, with the primary focus of the radiation being in the short wavelength range from 750 to 1200 nanometres.

### PRIORITY

This application claims priority from Provisional U.S. Patent Application Ser. No. 60/405,521, filed Aug. 22, 2002, incorporated herein by reference.

### BACKGROUNG OF THE INVENTION

The invention relates to the curing of powder coatings on metallic and non-metallic substrates by irradiation with selected near infrared (NIR) radiation.

Over the years, powder coatings have been used for many different surface coating applications and numerous powder coating formulations have been developed for these various areas of use. Once applied onto the substrate, the powder coating formulations may be cured by various processes. Examples are thermal processes using convection ovens, infrared light emitters or combinations thereof, treatment with UV radiation and irradiation with radiation in the near infrared (NIR) range of the spectrum.

NIR radiation is high intensity radiation of a wavelength range from 750 to 1200 nanometres. The wavelength range of conventional NIR radiation emitters generally covers a spectrum from 250 to 5500 nanometres, with the primary focus being in the short wavelength range. NIR technology makes it possible to cure powder coatings without substantially heating the coated substrate. Powder coatings can be fused and cured in a single process step without the disadvantages of conventional thermal curing, such as exposure to elevated temperatures, or the disadvantages of UV curing, such as multiple process steps and incomplete curing in pigmented systems. In the NIR process, the entire coating layer is uniformly heated and the radiation is reflected from metallic surfaces, see K. Bär, “Sekundenschnelle Aushärtung von Pulverlack” [Powder Coatings Cured in Seconds], JOT 2/98.

EP-A 1 137 723 describes a process for curing powder coatings with NIR radiation, in which curing times and the surface temperatures of the substrates coated with the powder coatings are controlled by appropriate contents of barium sulfate and/or aluminium oxide and/or carbon black.

EP-A 1 280 176 describes a process for the production of weather resistant powder coatings by using powder coating compositions based on certain polyester resins and curing by NIR radiation.

EP-A 1 056 811 discloses a process for producing powder coatings and curing the coatings by NIR irradiation, in which the powder coating compositions contain resins with a specific content of functional groups which are capable of forming hydrogen bridge bonds.

When powder coatings are cured with NIR radiation, in particular on metallic substrates, problems may arise with regard to coating quality, especially on complicated 3D (three dimensional) geometries. Due to the high speed of fusion and curing with NIR irradiation, which may for example be of the order of e.g. 1 to 7 seconds, changes in film formation may sometimes be unavoidable in comparison with conventional systems (which take some 700 to 900 seconds). Variations in surface quality taking the form of waviness, dulling and pinholes may, for example, occur. Moreover, as layer thickness increases, air may be entrapped, which may impair flow and the mechanical properties of the film.

### SUMMARY OF THE INVENTION

This invention provides a process for curing powder coatings which makes it possible to fuse and cure powder coatings using NIR radiation and which gives rise to coatings having improved mechanical properties, improved flow and increased uniformity of surface gloss of the coating.

The process for curing powder coatings is characterized by fusing and curing the powder coatings with NIR radiation, which radiation spectrum is restricted by controlled filtration of the NIR radiation to a wavelength range of 250 to 3000 nanometres, preferably of 400 to 1800 nanometres, with the primary focus of the radiation being in the short wavelength range from 750 to 1200 nanometres.

Surprisingly, due to the restriction of the radiation spectrum according to the invention, the process according to the invention makes it possible to control film formation and cross-linking of the powder coatings in such a manner that degassing of the powder coating layer can proceed straightforwardly, the coating exhibits improved flow and surface properties, such as, uniformity of surface gloss as well as mechanical properties of the cured coating may be improved significantly in quality.

### DETAILED DESCRIPTION OF THE INVENTION

The process is carried out according to the invention in that the radiation from the NIR lamps is filtered by using various filters having specific characteristics. In this manner, the spectral distribution of the radiation from the NIR lamps may be restricted to a wavelength in the range from 250 to 3000 nanometres, preferably from 400 to 1800 nanometres and more preferably, from 750 to 1200 nanometres.

The wavelength range of conventional NIR lamps conventionally encompasses a spectrum from 250 to 5500 nanometres, wherein the primary focus is in the short wavelength range, with approx. 80% of the integrated radiation output being in the wavelength range from 750 to 2500 nanometres.

Using specific filters, it is possible to restrict the wavelength range of the lamps in such a manner that radiation of a wavelength of above 1800 nanometres is virtually completely masked out. Radiation of a wavelength range of <400 nanometres, preferably of <750 nanometres, may likewise be masked out.

The applied powder coating composition may, for example, be cured using conventional high energy NIR radiation emitters. It is, for example, possible to use NIR radiation emitters with an emitter surface temperature of the incandescent coil of between 2000 and 3500 K. Power output is, for example, greater than 1 W/cm², preferably greater than 10 W/cm². The irradiation period may, for example, be within a range from 0.5 to 300 seconds, preferably from 1 to 60 seconds. On irradiation, the powder first fuses and then cures, for example, in a period from 0.5 to 60 seconds.

NIR radiation emitters which may be used are conventional, for example based on halogen lamps, in particular high power halogen lamps. Radiation emitters suitable for the process according to the invention are commercially available, for example, from Adphos AG, for example those based on halogen lamps with a coil temperature of up to 3500° K.

It is also possible to use a combination with conventional heat sources (infrared radiation, convection ovens, gas infrared radiation emitters), optionally together with additional reflector/lens systems.

In particular, the process according to the invention is also suitable for curing powder coated three-dimensional objects, wherein in this case uniform irradiation may be achieved by additionally using a combination with conventional heat sources and/or reflectors for the NIR radiation.

The powder coating compositions usable according to the invention may contain conventional binder/curing agent systems, such as, for example, polyester resins with low molecular weight epoxy and/or hydroxyalkylamide curing agents and/or dimerized isocyanates (uretidiones) and/or blocked isocyanates, epoxy/polyester hybrid systems, epoxy resins with dicyandiamide curing agents, carboxylic acid curing agents or phenolic curing agents, or also epoxy-functionalized acrylate resins with carboxylic acid or carboxylic anhydride curing agents, together with conventional pigments and/or extenders and conventional additives, such as, for example, levelling agents, degassing agents, texturing agents, flatting agents and the like. The powder coating compositions usable according to the invention may be colored using conventional organic or inorganic pigments or dyes as well as metallic and/or non-metallic special effect-imparting agents.

Powder coatings which are suitable for curing with NIR radiation are described, for example, in WO 99/41323.

The powder coatings usable according to the invention may be produced in conventional manner, for example, using known extrusion/grinding processes, production of powders by spraying from supercritical solutions, the non-aqueous dispersion (NAD) process or ultrasound standing wave atomization (USWA) process.

The powder may be applied onto the substrate to be coated using known electrostatic spraying processes, for example, using corona or tribo spray guns or with other suitable powder application processes, for example, application in the form of an aqueous dispersion (powder slurry) or by means of broad band spreading processes.

Various filters with specific characteristics may be used individually or in combination with one another for filtering the radiation from the NIR lamps. Such filters are, for example, filters based on borosilicate glass (with iron oxides), silica glass, vitreous ceramic. Such filters may additionally be coated on one or both sides, for example with absorbent or reflective substances. Examples of such filters are Borofloat®, Borofloat®-IR, Robax®, Robax®-IR, Quarz-IR from the companies Irlbacher Glas Technik & Handel, UNAXIS Optics, Schott, Melles Griot. Filters based on vitreous ceramics and borosilicate glasses, for example, Robax® IR coated on both sides and Borofloat® IR, are preferably usable.

The coatings obtained using the process according to the invention have excellent flow, irrespective of layer thickness, improved mechanical properties and exhibit improved uniformity of surface gloss without defects. The coating may furthermore straightforwardly be degassed over the coating thickness range of relevance to practical applications of 50 to 150 μm, so resulting in substantially improved film properties.

The powder coatings obtained using the process according to the invention may be used for any conventional powder coating applications. Substrates which may be used are, for example, metals, such as, aluminium, steel, as well as derived timber products or plastics surfaces. In particular, functional coatings may also be applied onto pipes, metal components for concrete reinforcement or structural elements, and coatings may also be applied onto complicated three-dimensional objects. The process according to the invention may also be used at various coating speeds in the coil coating process.

The following examples illustrate the invention.

### EXAMPLES

Production of a Powder Coating

The raw materials are weighed by their percentages of weight and mixed in dry state in a nutating-piston mixer for 10 min. to form a homogeneous premix. This premix is then dispersed by means of an extruder, for example, type ZSK 25 of Messrs. Werner & Pfleiderer, at temperatures between 80 and 120 centigrades. The extrudate thus resulting is sheeted out as film of approx. 1-2 mm thickness using a cooled press roll and cooled down to <35° C. so that the film can subsequently be broken into small pieces (chips, approx. 0.5 to 1 cm) by means of a crusher. These chips are pulverized to a powder having a statistical particle-size distribution of 1 to 100 microns by means of a classifier mill, for ex. type Mikropul CM 2 L of Messrs. Mikropul.

### Example 1

Production of a Powder Coating Based on a Polyester Resin

The following components are premixed: 62.6% polyester resin Alftalat® 03640 (Company Solutia), 4.86% curing agent Araldit PT 910 (Company Vantico), 3.3% flow agent and de-gassing agent Benzoin (Company VAT Chemicals) and Additol® VXL 9824 (Company Solutia), 4.3% filler Blanc fixe (Company Sachtleben) as well as 25% titanium dioxide pigment Tipure 960 (Company DuPont).

### Example 2

Production of a Powder Coating Based on an Epoxide Resin

The following components are premixed: 57.2% epoxide resin Epikote® 1002 (Company Shell), 17.1% curing agent HT 3082 (Company Vantico), 0.7% flow agent Resiflow® PV 88 (Company Worlee), 3% filler Blanc fixe as well as 22% titanium dioxide pigment Tipure 960.

Application and Measurement of Surface Properties

All powder coating tests were performed on 1 mm thick chromated aluminium sheet. The powder coatings were applied in conventional layer thicknesses of on average 70 to 80 μm and were fused and cured by means of NIR radiation.

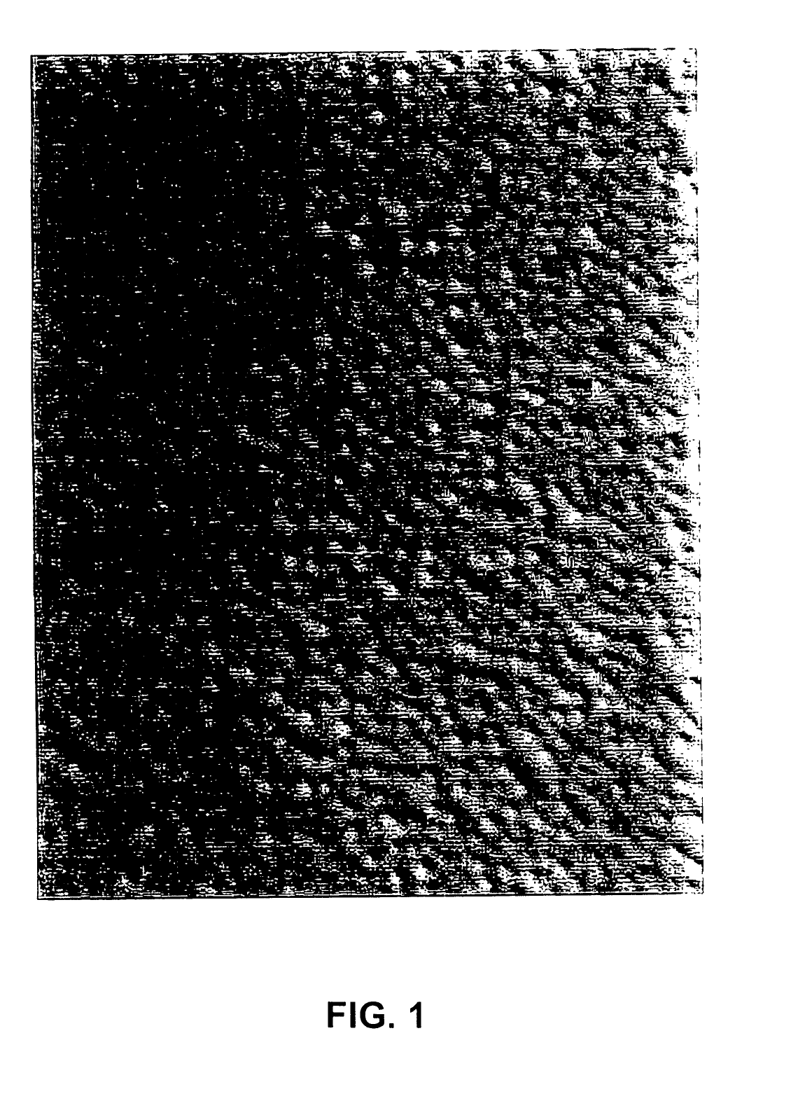

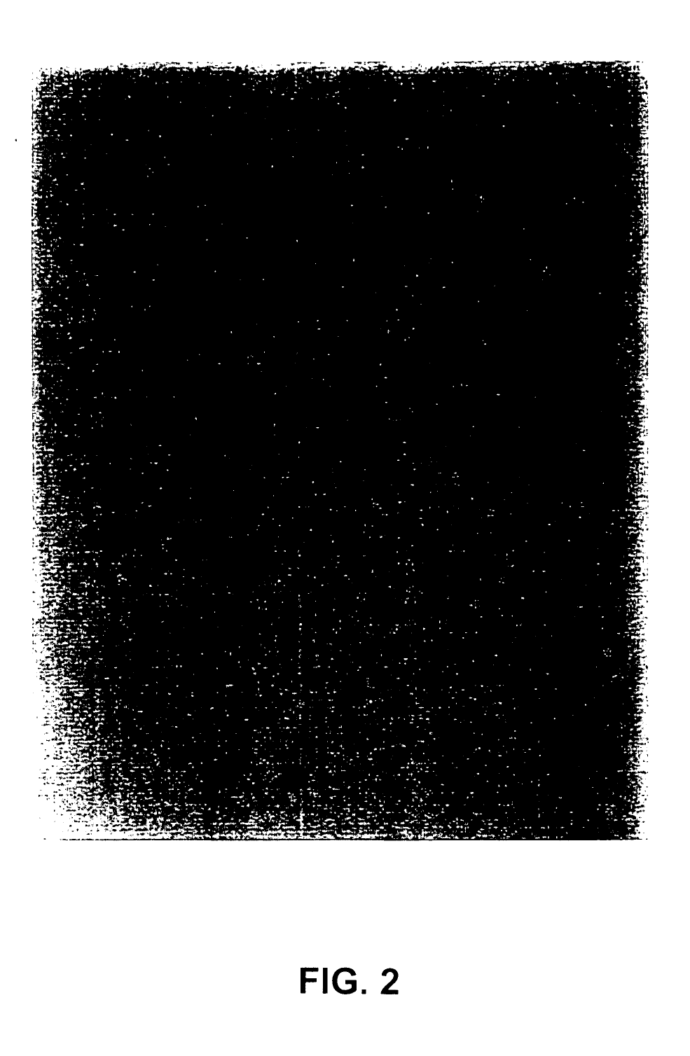

Results: see Table and FIGS. 1 and 2

TABLE

| Parameter | Evaluation without filter | | Evaluation with filter |
|---|---|---|---|
| Entrapped air | Quantity: m 5 | | Quantity: none |
| (ground cross- | Size: g 2-3 | | Size: not applicable |
| section) | | | |
| Gloss (60° angle) | 60 | | 85 |
| (DIN 67530) | | | |
| Flow (Wave Scan) | Long Wave: 40-50 | | Long Wave: <20 |
| Impact test (inchp) | Example 1: | <10 | >40 |
| (ASTM D 2794) | Example 2: | <10 | >60 |
| Flexural test (DIN | Example 1: | >10 | <3 |
| EN ISO 1519) | Example 2: | >8 | <3 |

FIG. 1 (attached) Surface after curing without filter (wavelength >1800 nm)

FIG. 2 (attached) Surface after curing with filter (wavelength >1800 nm)

After curing by means of filtered NIR radiation, the coated surfaces of the metallic sheets do not show any entrapped air and furthermore exhibit a significantly improved gloss of the coating, shown by the above Table and by FIGS. 1 and 2. Apart from this, the flow properties of the coating are improved (see Wave scan results in the Table). The impact test as well as the elongation tests (Flexural test) in the Table show improved results compared with curing by means of unfiltered NIR radiation.

1. A process for applying and curing a powder coating which comprises the steps of (1) applying the powder coating to a substrate; (2) irradiating the applied powder coating with near infrared (NIR) radiation using NIR emitters, wherein the NIR radiation emitted from the NIR emitters has a wavelength ranging from about 250 to about 5500 nm; and 3) providing filters for the NIR emitters, wherein said filters are coated filters selected from borosilicate glass, silica glass, and vitreous ceramic; wherein said filters restrict the wavelength of the NIR radiation emitted from the emitters is to a wavelength ranging from 250 to 3000 nm, wherein the restricted NIR radiation primarily has wavelength ranging from 750 to 1200 nm.

2. The process according to claim 1 wherein said filters restrict the wavelength of the NIR radiation emitted from the emitters to a wavelength ranging from 750 to 1800 nm.

3. The process according to claim 1 wherein a combination is used of the NIR irradiation with a conventional heat source.

4. The process according to claim 3 wherein the conventional heat source is selected from the group consisting of infrared radiation, convection heat and gas infrared radiation emitters.

5. (canceled)

6. The process according to claim 5 wherein the coated filters are coated on one or both sides with absorbent or reflective substances.

7. The process according to claim 1 wherein the powder coating is cured in a period from 0.5 to 60 seconds.

8. The process according to claim 1 wherein three-dimensional substrates are coated and cured.

9. (canceled)
